(19) United States
(12) Patent Application Publication
(10) Pub. No.: US 2012/0190412 A1
(43) Pub. Date: Jul. 26, 2012

(54) CELLULAR PHONE CHARGER WITH DATA BACK-UP CAPABILITIES

(76) Inventor: Spartak Buniatyan, Burbank, CA (US)

(21) Appl. No.: 13/354,133

(22) Filed: Jan. 19, 2012

Related U.S. Application Data
(60) Provisional application No. 61/434,388, filed on Jan. 19, 2011.

(51) Int. Cl. H04M 1/00

(52) U.S. Cl. 455/573

(57) ABSTRACT

A mobile phone charger is provided with wireless communication capabilities. The mobile phone charger may include a first interface to couple to a mobile phone, a charging circuit adapted to provide power to the mobile phone via the first interface, and/or a data backup circuit adapted to read data from the mobile phone and/or write data to the mobile phone via the first interface. Additionally, the mobile phone charger may include a data storage circuit adapted to store the data read from and/or written to the mobile phone. The first interface may charge the mobile phone while concurrently backing up data from the mobile phone. The mobile phone charger may include a communication interface adapted to facilitate wireless communications between the mobile phone charger and one or more other devices. The data stored by the data storage circuit may be accessible from a remote device via the communication interface.

### CROSS-REFERENCE TO RELATED APPLICATIONS

This application claims priority to and the benefit of provisional patent application No. 61/434,388, filed in the United States Patent and Trademark Office on Jan. 19, 2011, the entire content of which is incorporated herein by reference.

### BACKGROUND

1. Field

One feature relates to mobile phone charging devices, and more particularly, to mobile phone charger with integrated data backup and/or storage features.

2. Background

With the increased dependence of wireless users on their cellular phones as personal organizers and data storage units, data-loss is a significant problem faced by most wireless phone users. Current solutions for data back-up from cellular phones are only software based and are available either as PC-based software, which require installation of drivers or software and require connection to a PC, or as a carrier-based solution, which entails monthly fees and never give the consumer privacy or control over their data. Because of the short-fallings of current data back-up solutions for wireless cellular phones, many users are not adequately protected against the risk of data loss.

There are two types of software-based data backup technologies currently available. For each of the two types of data backup solutions currently available directly to consumers, the following problems have been identified.

PC-Based software that retrieves the phone's data via a physical (i.e. USB or Bluetooth) connection to the phone.
This typically requires installation of drivers and/or software
PC-dependence
Difficult/Intimidating to use
Typically a Bluetooth connection does not allow for charging the phone at the same time the phone's data is retrieved.

Mobile software that must be set-up on the phone, which uploads data to the carrier's server.
Requires monthly subscription to back-up service provider
Requires account set-up
Lack of privacy and control over data
Locks consumer to carrier providing the back-up service

Therefore, a solution is needed that addresses the above problems (i.e. P.C. dependence, ease of use, and privacy) while preventing data loss, allowing data to be relatively easily accessible, and/or providing multi-user support.

### SUMMARY

A mobile phone charger is provided with wireless communication capabilities. The mobile phone charger may include a first interface to couple to a mobile phone, a charging circuit adapted to provide power to the mobile phone via the first interface, and/or a data backup circuit adapted to read data from the mobile phone and/or write data to the mobile phone via the first interface. Additionally, the mobile phone charger may include a data storage circuit adapted to store the data read from and/or written to the mobile phone. The first interface may charge the mobile phone while concurrently backing up data from the mobile phone. The mobile phone charger may include a communication interface adapted to facilitate wireless communications between the mobile phone charger and one or more other devices. The data stored by the data storage circuit may be accessible from a remote device via the communication interface.

### BRIEF DESCRIPTION OF THE DRAWINGS

The accompanying drawings, together with the specification, illustrate exemplary aspects of the present disclosure, and, together with the description, serve to explain the principles of the present invention.

FIG. 1 is a block diagram illustrating a mobile phone charger with integrated wireless communication and/or data backup capabilities.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams, or not be shown at all, in order not to obscure the embodiments in unnecessary detail. In other instances, well-known circuits, structures and techniques may not be shown in detail in order not to obscure the embodiments.

The present description includes devices and methods relating to the U.S. Provisional Patent Application No. 61/427,163 filed Dec. 24, 2010, the entire disclosure of which, including all appendices, is incorporated herein by this reference.

The cellular phone charger with data back-up capabilities will be used to charge a cellular phone and back-up its data at the same time, while providing users complete control over and privacy with respect to their data. It can be used by consumers on a daily basis anytime they need to charge their phone. In addition to charging the cellular phones, the present methods and devices automatically back-up all data on the phone.

Storage Options: There are several storage mediums that can be used. Some examples of storage options that the product can take include:
The storage can be on a removable storage medium (e.g., SD card).
The charger itself can have an internal flash storage system, or other permanent storage media.

Compatibility: Depending on the preferred configuration of the technology license. The device can function as a universal solution (i.e. housing several different detachable cables or phone connectors) via a standard USB port. Alternatively, the device can be configured to be brand-specific (e.g., for all Motorola phones) or phone-specific, based on the specifications and demands of the licensee/customer.

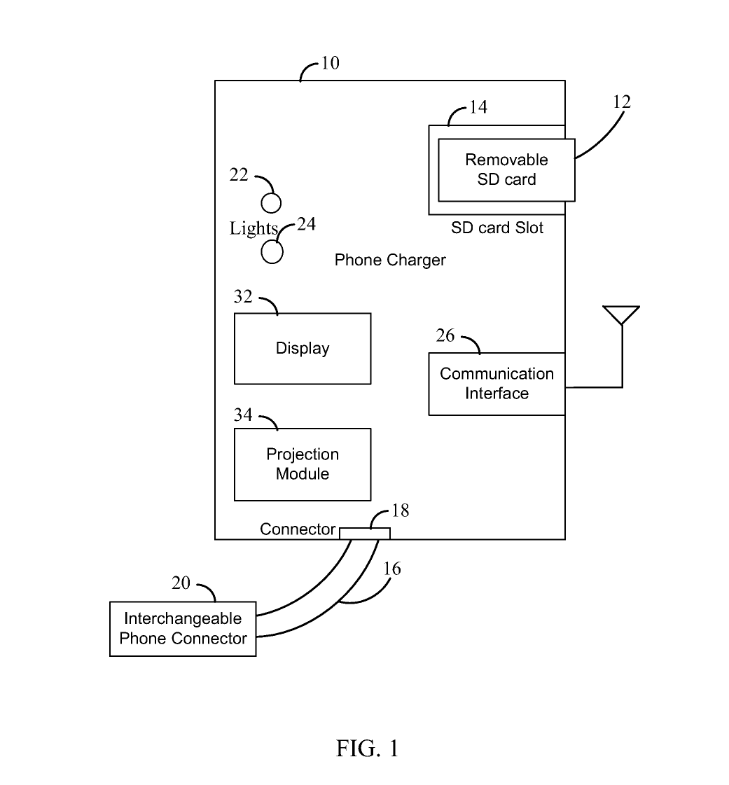

In FIG. 1, a block diagram is illustrated according to at least one embodiment. FIG. 1 shows a cellular phone charger 10 with a data storage circuit in the form of a removable SD card 12, which slides into the SD card slot 14, which slot can be integral with the cellular phone charger 10.

The device connects to a cellular phone via a first interface which connects to the cellular phone charger 10. For example, the charger 10 may include a first interface in the form of a detachable USB cable 16 coupled to a USB connector 18 of the charger 10. The detachable USB cable 16 may be coupled to the cellular phone USB communication port via an interchangeable phone connector 20.

The charger 10 can be equipped with one or more user interfaces, for example, to indicate charging status and/or backup status. For instance, in some embodiments, the charger 10 can be equipped with an LED status indicator lights, such as a green light 22 which lights up to indicate a charging status and a red LED light 24 which lights up to indicate a backup status.

In at least some embodiments, the charger 10 may be equipped with audio capabilities adapted to audibly indicate a charging and/or backup status. Such audio capabilities may include voice output to audibly tell the user a status.

In some embodiments, the charger 10 may include a display 32 (e.g., LCD) providing status information to the user.

In at least some embodiments, the charger 10 may include a projection module 34 adapted to project status information on, for example, a nearby or adjacent wall.

In more detail, still referring to the device in FIG. 1, the charger 10 is connected to a cellular phone via the interchangeable phone connector 20, which is attached to a detachable USB cable 16, and upon such connection, a charging circuit of the charger begins to charge the attached cellular phone and a data backup circuit simultaneously backs-up all data on the phone and copies it onto the applicable sub-folder in the data storage circuit (e.g., removable SD card 12). It is noted that the detachable USB cable 16 may also comprise a conductor integrated into the charger 10, and the interchangeable phone connector 20 may also be integral with the charger 10, such that a cellular phone may be physically attached directly to the charger 10, in some embodiments.

In further detail, still referring to the device of FIG. 1, the SD card slot 14 is sufficiently small to fit into a standard wireless phone charger without the need to increase the size of a charger.

In one example, the charger and backup device may operate as follows:
1. Charger and backup device (CBD) connects with Cellular Phones communication port.
2. CBD detects phone connection through USB data channel.
3. CBD identifies Cellular Phones Brand, Model, and Serial ID.
4. CBD loads the proper Communication Protocol to communicate with cellular phone.
5. CBD issues proper “activate charger” commands through phones USB interface
6. Backup operation begins:
   a. CBD verifies Serial Id of the Cellular Phone with the Serial Id of the last backup transactions.
   b. If a match is found, CBD updates the previous stored backup operation, otherwise new directory is created.
   c. During Backup operation, CBD flashes the LED.
7. After completion of Backup/Restore operation, CBD logs connection details and generates
   a. txt, csv file for easy importing of data.
   b. Html data gallery file of easy viewing and navigating content of sd card.
   c. Other types of PC based data files
8. CBD issues proper termination commands and terminates connection USB.

During the Termination Process, CBD lights the LED according the transaction status.

### Wireless Communication Capabilities

Referring again to FIG. 1, in at least one embodiment, the charger 10 may further include a communications interface 26 adapted to facilitate wireless and/or wired communications for the charger 10. For example, the communications interface 26 may be adapted to wirelessly communicate with one or more other devices using one or more wireless communication standards, such as IEEE 802.11 (i.e., WiFi), Bluetooth, IEEE 802.15.4-2003 (i.e., Zigbee), or other known wireless communications standards.

In such embodiments, the charger 10 can be adapted to host the backed-up data for relatively easy access from a personal computer and/or the internet in general. In addition, the charger having a communications interface 26 may be adapted to facilitate posting of backed-up data (e.g., documents, photos, videos, notes, calendars, etc.) to websites and social media sites (e.g., facebook, my space, etc.).

According to at least one implementation, the charger 10 can include an IP address, enabling data stored by the charger 10 to be accessed via an internet browser. For example, a user can simply enter the web address (e.g., the IP address) for the charger 10, which charger 10 includes a network connection (e.g., internet or intranet) via the communications interface 26. The entered web address may pull up some or all of the latest data saved at the charger 10 from the most recent backup of the user's cellular phone. For example, the user may be able access photos, documents, videos, notes, calendars, and more or different data that was backed-up from the user's mobile phone.

### Wireless Charging With Backup Capabilities

According to at least some embodiments of a charger that includes backup capabilities, the charger may be adapted for wireless charging. For example, instead of including a detachable USB cable 16 coupled with an interchangeable phone connector 20 that is capable of being coupled to a cellular phone, as described in the embodiment shown in FIG. 1, the charger 10 can include a wireless charging interface, such as a charging surface (e.g., a charge pad). Typically, a charging case or receiver case is coupled to the charging inputs of the cellular phone, such as to a USB port of the cellular phone. When a cellular phone that is coupled to a charging case is placed on the charging surface, the phone begins to charge. Such features are generally known in conventional wireless charging devices.

In at least one implementation, when the charging surface detects that a cellular phone having a charging case has been placed thereon to be charged, a wireless communications interface of the charger 10 is activated. The wireless communications interface may be at least part of the communications interface 26, or the wireless communications interface may be another interface that is adapted to facilitate, for example, wireless Bluetooth communications. The wireless communications interface may scan for a previously paired cellular phone and, upon connection with the cellular phone, may perform a data backup of the cellular phone via the Bluetooth communications.

In at least another implementation, the charging case may include its own wireless communication module adapted to communicate with the wireless communication interface of the charger 10. The wireless communication module is communicatively coupled to the cellular phone. For example, as noted above, the charging case may be coupled to a USB port of the phone. In this manner, the wireless communication module may also be coupled to the USB port of the phone. Using such a connection, the wireless communication module can obtain the data to be backed up from the cellular phone, and transmit the data to the charger for backup. For example, the wireless communication module of the charging case can be activated once when the charging case detects the charging surface, and begin to wirelessly transmit the data to the charging base.

It should be recognized that, generally, most of the processing described in this disclosure may be implemented in a similar fashion. Any of the circuit(s) or circuit sections may be implemented alone or in combination as part of an integrated circuit with one or more processors. The one or more of the circuits may be implemented on an integrated circuit, an Advance RISC Machine (ARM) processor, a digital signal processor (DSP), a general purpose processor, etc.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

As used in this disclosure, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

One or more of the components, steps, and/or functions illustrated in the Figures may be rearranged and/or combined into a single component, step, or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features described herein can be implemented in different systems without departing from the disclosure.

It should be noted that the foregoing embodiments are merely examples and are not to be construed as limiting. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A mobile phone charger, comprising:
a first interface to couple to a mobile phone;
a charging circuit adapted to provide power to the mobile phone via the first interface;
a data backup circuit adapted to read data from the mobile phone and/or write data to the mobile phone via the first interface; and
a data storage circuit adapted to store the data read from and/or written to the mobile phone.

2. The mobile phone charger of claim 1, wherein the first interface can charge the mobile phone while concurrently backing up data from the mobile phone.

3. The mobile phone charger of claim 1, further comprising a communication interface adapted to facilitate wireless communications between the mobile phone charger and one or more other devices.

4. The mobile phone charger of claim 3, wherein the data stored by the data storage circuit is accessible from a remote device via the communication interface.

5. The mobile phone charger of claim 1, further comprising:
a user interface including at least one of an status lights, audio output capabilities, a display or a projection module.

6. A mobile phone charger, comprising:
a wireless charging interface;
a charging circuit adapted to provide power to a mobile phone via the wireless charging interface;
a wireless communication interface; and
a data backup circuit adapted to read data from the mobile phone and/or write data to the mobile phone via the wireless communication interface.

7. The mobile phone charger of claim 6, wherein the wireless communication interface is adapted to scan for and wirelessly connect with the mobile phone when the mobile phone begins charging via the wireless charging interface and prior to reading data from and/or writing data to the mobile phone.

8. The mobile phone charger of claim 6, wherein the wireless communication interface is adapted to communicate with a wireless communication module of a charging case coupled to the cellular phone, the wireless communication module being communicatively coupled to the cellular phone to access the data to be backed up.

9. The mobile phone charger of claim 6, further comprising at least one user interface including at least one of an LED, audio output capabilities, an LCD or a projection module.

10. The mobile phone charger comprising:
means for interfacing the mobile phone charger to a mobile phone and providing power to the mobile phone; and
means for reading data from the mobile phone and/or write data to the mobile phone via a wireless communication interface.
